(19) United States
(12) Patent Application Publication
(10) Pub. No.: US 2003/0103410 A1
(43) Pub. Date: Jun. 5, 2003

(54) Device for mixing at least two fluids

(76) Inventor: Gerd Scheying, Stuttgart (DE)

Correspondence Address: KENYON & KENYON, ONE BROADWAY, NEW YORK, NY, 10004, US

(21) Appl. No.: 10/278,597

(22) Filed: Oct. 22, 2002

(30) Foreign Application Priority Data
Oct. 23, 2001 (DE) 101 52 115.4-23

(51) Int. Cl. B01F 7/26; B01F 15/02

(52) U.S. Cl. 366/195; 366/316; 366/332

(57) ABSTRACT

A device for mixing at least two substances, for example, two fluids, includes a mixer housing having a mixing chamber, in which a mixing tool is situated. The mixing tool may be actuated like similar to a plunger with linear motion and has a connection for an actuating device.

### FIELD OF THE INVENTION

The present invention is directed to a device for mixing at least two substances, for example, two fluids.

### BACKGROUND INFORMATION

To mix substances, for example, fluids, such as gases and/or liquids, numerous devices and methods are available to mix components that differ in at least one characteristic. A mixing method employed may be adapted to the aggregate states, the flow characteristics, the mixing proportions and to the desired degree of homogenization of the substances or media to be mixed.

In an agitating mixer, for example, a mixing tool (i.e., an agitator) rotates in a static or moving mixing chamber, into which the substances to be mixed are introduced.

Static mixers include assemblies with fixed built-in elements, and in which fluid streams of product are mixed using kinetic energies.

Mixers for high-viscosity media may permit cross-mixing of the media to be achieved using artificially generated turbulences. For example, in the case of viscoplastic media, stagnation zones may occur without such turbulences. Mixers for high-viscosity media include, for example, helical ribbon mixers, anchor mixers, coaxial mixers and multiple-shaft mixers. In addition, planetary mixers, trough mixers, stamp kneaders and screw mixers may also be employed for mixing high-viscosity media. With respect to these mixing devices, the mixing of the media may occur at least in part through rotation of a mixing tool.

A grease kneader may be used to influence the flow properties of lubricating greases. The grease kneader includes a housing having a kneading chamber, into which lubricating grease is introduced. The lubricating grease may be processed in the kneading chamber by a manual upward and downward movement of a beating plunger.

### SUMMARY

It is believed that an exemplary device according to the present invention for mixing at least two substances, for example, two fluids, in which the mixing tool is actuatable similar to a plunger with linear motion and has a connection for an actuating device, advantageously permits a homogeneous mixing of the substances or media. The mixing of the substances may occur, for example, by repeated, axially-oriented linear motions of the plunger-like mixing tool in the mixing chamber.

Using an exemplary device according to the present invention, a plurality of fluids may be automatically and homogeneously mixed in various proportions and suspensions. The exemplary device according to the present invention effectively mix high-viscosity homogeneous liquids, for example, viscoplastic fluids, which have liquid limits, as well as thixotropic media. Intrinsically viscous fluids, which would produce a Weissenberg effect in an agitating mixer as a result of their viscous elasticity, may also be adequately miscible using the exemplary device according to the present invention. Furthermore, Bingham fluids and fluids having pronounced dilatancy may be easily handled using the exemplary device according to the present invention.

Accordingly, the exemplary device of to the present invention permits the effective mixing of suspensions and foams, which represent fluids in the broadest sense, and with which only inadequate mixing would be possible using conventional agitating mixers. In contrast to mixing using an agitating mixer, when using the exemplary device according to the present invention, which represents a sort of “linear mixer,” there is little or no melt fracture with these fluids, in which a fluid fractures internally as a result of insufficient mixing and hence elevated shear stress, causing large portions of the volume of the fluids which are to be mixed to no longer participate in the mixing process.

The exemplary device according to the present invention may mix various substances, for example, fluids. The term “fluid” includes, for example, gases, liquids, high-viscosity fluids, suspensions, emulsions and aerogels.

The plunger-like mixing tool, using linear motion, may permit generally the entire volume of the mixing chamber to be used in the mixing process. For this purpose, a cylindrical mixing chamber may be employed, in which a disk-shaped mixing tool is arranged to move axially through the entire length of the cylinder.

In addition, the exemplary device according to the present invention may permit homogenous mixing of the media to be mixed, including Newtonian fluids, in a shorter time compared to rotation mixers, since the entire volume of the mixing chamber may be used and circulated from the first completed linear motion of the mixing tool on.

The mixing tool, for example, may be actuated by an actuating device that transfers a linear motion to the mixing tool. For example, the actuating device may include an electric motor.

To permit the integration of the exemplary device according to the present invention into a system in a fixed location and to ensure operation without previous or subsequent installation work, the exemplary device may, for example, include at least one filling opening connected to a filling line leading to a supply tank for fluid. The device may, for example, include at least two filling openings, so that one of the substances to be mixed may be conveyed into the mixing chamber through each filling opening. To prevent the substances from being expelled from the mixing chamber through the filling opening during mixing, the filling openings may each be equipped with a valve.

The substances to be mixed may, for example, be introduced into the mixing chamber through a single filling opening. A seven-way ballcock valve may, for example, be placed in the filling opening, so that up to, for example, seven different substances may be conveyed into the mixing chamber through one filling opening via appropriate control of the valve.

The mixture of the source materials may be extracted from the mixing chamber through the filling opening after mixing. However, the mixing chamber may be provided with a separate outlet opening for this purpose. In another exemplary device according to the present invention, the outlet opening operates together with a metering device, so that small quantities of suspension in metered volumes, for example a few μl drops, may, for example, be drawn from the mixing chamber from a nozzle attached to the metering device as a dispenser and then applied to a substrate matched to a particular application. In this case, the exemplary device according to the present invention may include a metering device.

According to another exemplary device of to the present invention, the mixing tool includes a mixing disk attached to a mixing tool shaft that extends to the outside of the mixer housing, at which it connects the mixing tool to the actuating device. Accordingly, this shaft is connected to the actuating device, at least during operation.

According to another exemplary device of the present invention, the linear mixer may permit the mixing tool to move rotationally. In this manner, during a stroke motion, the mixing tool may, for example, be rotated by small angular increments, for example, 15°, or even continuously, which may generate beneficial turbulences in the media to be mixed.

To help ensure that generally the entire volume of the mixing chamber is used in the mixing process during one complete stroke motion of the mixing tool, the diameter of the mixing disk may generally correspond to the inside diameter of the mixing chamber. The mixing disk may, for example, include an O-ring or the like on its periphery, which slides on the inner wall of the mixer housing during the stroke motion.

The mixing disk may include a plurality of holes or perforations, through which the substances to be mixed are pressed during the mixing process. For example, the holes may have a contour without sharp edges. The hole area may consume a large portion of the area of the mixing disk, to keep the milling resistance small during a mixing process.

The thickness of the mixing disk has generally no influence on the mixing process and depends primarily on the material used. A thickness of 500 μm may, for example, be sufficient. A small thickness of the mixing disk may offer advantage when cleaning the linear mixer.

The axes of the holes may be oriented at an angle to the mixing tool shaft. In this case, a stroke of the mixing disk produces an additional turbulence in the media to be mixed. For this purpose, the mixing disk should have a greater thickness, which may, for example, be 3 mm.

Another exemplary device of the present invention has an ejection piston with a piston shaft extending to the outside of the mixer housing. The piston shaft, which may be connected to an actuating device that is identical to the actuating device of the mixing tool, drives the ejection piston, so that the mixed substances may be ejected from the mixing chamber through the outlet opening from outside the mixer housing.

The metering device, which works together with the outlet opening, may, for example, include a stem operating as a valve needle. This stem may serve as a guide for the mixing tool shaft and the piston shaft, and may be positioned coaxially to both of them.

Metering of the mixed substances may be accomplished through a defined displacement of the ejection piston, which is also associated with the metering device and lifting the stem from its seat in the area of the outlet opening.

The coaxially positioned shafts and the stem positioned coaxially to the shafts extends through a common opening in the mixer housing to the outside of the mixer housing, and are sealed by a radial shaft seal or the like. The seal may largely prevent direct contact of the sealing surface with abrasive components, for example, with ceramic particles in an organic medium or substances to be mixed.

An exemplary device according to the present invention may include a vent valve for expelling air during filling of the mixing chamber. A filter frit or the like may be placed upstream from the vent valve.

Since generally the entire mixed medium may be expelled from the mixing chamber using the ejection piston, cleaning the mixing chamber is simplified. For this purpose, a cleaning fluid may be introduced into the mixing chamber through the filling opening, circulated by the mixing disk, and drained from the mixing chamber through the outlet opening.

An exemplary device according to the present invention may include a plurality of rods positioned axially in the mixing chamber, all of which extend through the holes in the mixing disk, are oriented parallel to the mixing disk shaft, and pass close to the edges of the holes. Such an exemplary embodiment according to the present invention may, for example, be suited for mixing waxy media, in which turbulences that encourage mixing may be generated with a stroke of the mixing disk.

### BRIEF DESCRIPTION OF THE DRAWINGS

FIG. 1 is a sectional view of an exemplary mixer according to the present invention.

FIG. 2 is a top view of a mixing tool of the exemplary mixer illustrated in FIG. 1.

### DETAILED DESCRIPTION

The exemplary embodiment depicted in the drawings shows a device 10 for mixing fluids, which may be integrated into a system and/or may be used for automated actuation.

Device 10 is a linear mixer having a mixer housing 11, which includes two parts and a pot-like, cylindrical container 12 closed by a bottom 13. Bottom 13, for example, may be screwed onto container 12 with threading 14.

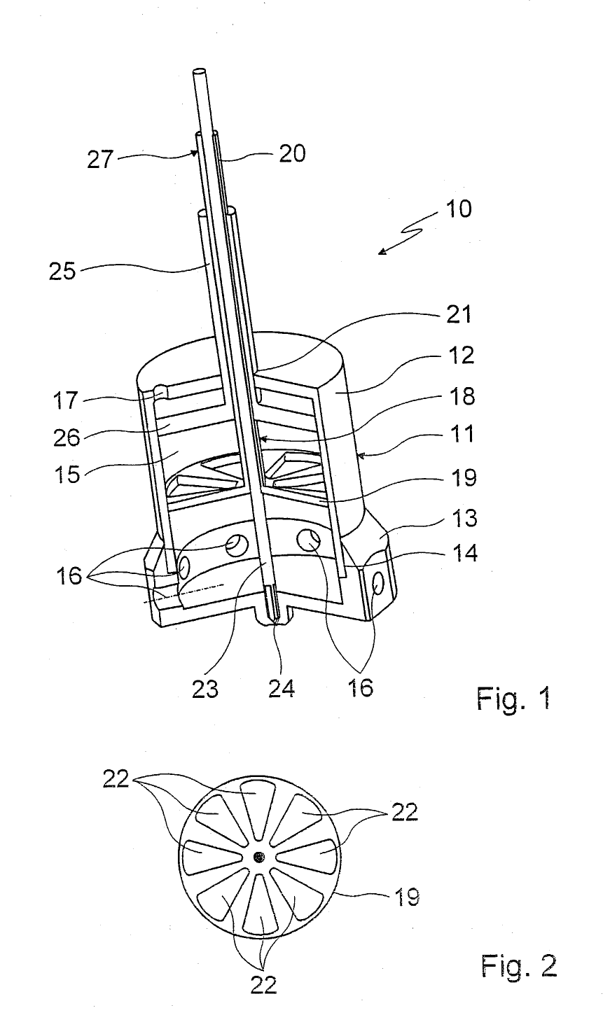

Mixer housing 11 includes a cylindrical mixing chamber 15 having a diameter of about 1.8 cm. For filling mixing chamber 15 with fluids to be mixed, eight filling openings 16 are provided on bottom 13, of which five are shown in FIG. 1. The filling openings 16 pass through bottom 13 in the radial direction with respect to the axis of mixer housing 11. Each of filling openings 16 is provided with a check valve (not shown) to prevent the fluids to be mixed from being expelled from mixing chamber 15 through filling openings 16 during a mixing process.

In addition, on the face of container 12 opposite bottom 13, a vent opening 17 is provided, which may, for example, include an inlet valve (not shown) upstream, from which a filter frit may be positioned.

Linear mixer 10 is equipped with a plunger-type mixing tool 18, having a mixing disk 19 attached to a mixing tool shaft 20, which extends through a central bore 21 located in the face of container 12 opposite bottom 13 to the outside of mixer housing 11. The maximum stroke of mixing tool 18 is about 3 cm.

In the exemplary embodiment illustrated in FIG. 2, mixing disk 19 has a diameter of about 1.75 cm and a thickness of 500 μm, and has eight perforations 22, through which the fluids to be mixed are pressed during a mixing process. The diameter of mixing disk 19 generally corresponds to the diameter of mixing chamber 15. In addition, mixing disk 19 has a rubber ring (not shown) on its periphery that slides along the inner wall of mixer housing 11 during a stroke motion of mixing tool 18.

Mixing tool shaft 20 is guided on a stem 23 acting as a valve needle, which also extends through bore 21 and, in its closed position, extends through mixing chamber 15 in the axial direction and cooperates with an outlet opening or nozzle 24 located in the center of bottom 13.

Mixing tool shaft 20 guides a piston shaft 25 that is connected to an ejection piston 26, which is oriented parallel to mixing disk 19. Piston shaft 25, which is positioned coaxially to mixing tool shaft 20 and stem 23, drives ejection piston 26.

Stem 23, mixing tool shaft 20, and piston shaft 25 form a connection outside of mixer housing 11 for an actuating device (not shown), so that a linear stroke motion applied by the latter in the axial direction with respect to the axis of mixer 10 may be transferred. In addition, mixing tool shaft 20 may permit the transfer of a rotational motion to mixing disk 19.

Linear mixer 10 described above works in the manner described below.

To fill mixing chamber 15, at least two fluids are introduced through filling openings 16 into mixing chamber 15 in defined mixing proportions, ejection piston 26 being in a retracted position, i.e., against the boundary wall of container 12 having bore 21. However, ejection piston 26 may be held in a different position, while mixing chamber 15 is being filled, so that the volume of mixing chamber 15 is reduced. Ejection piston 26 is controlled via piston shaft 25. While mixing chamber 15 is being filled, the vent valve arranged in vent opening 17 is open, so that the gases present in mixing chamber 15, for example, air, may be displaced, and complete filling may be permitted. The fluids to be mixed may be fed via a volumetrically operating pressure-volume transport system from a supply vessel, through lines each being connected to a filling opening 16.

After mixing chamber 15 is filled, the check valves associated with filling openings 16 and the vent valve associated with vent opening 17 are closed.

After the check valves and the vent valve are closed, the actual mixing process begins. Mixing disk 19 is moved by mixing tool shaft 20 repeatedly back and forth through the entire axial extent of mixing chamber 15. The stops for mixing disk 19 are ejection piston 26 on one side and the inner wall face of bottom 13 on the other side.

After the completion of each stroke, or during the individual strokes, mixing tool shaft 20 and mixing disk 19 are rotated by discrete angular increments. The angular increment of rotation may, for example, be 15°, so that even intrinsically viscous suspensions are mixed sufficiently homogeneously. The entire volume of mixing chamber 15 is used in the stroke motions of mixing disk 19, so that the fluids introduced into mixing chamber 15 through filling openings 16 may be homogeneously intermixed. Consequently, the entire volume of fluid is circulated during the mixing process.

After mixing, the mixture of the fluids is metered out through outlet opening or nozzle 24 cooperating with stem 23. For this purpose, ejection piston 26, which is actuatable by piston shaft 25, is shifted by a defined increment in the direction of cover 13. In the ejection process, pressure piston 26 is guided behind mixing tool 18, which includes a perforated plunger. Ejection piston 26 and stem 23, which form a metering device may be moved, so that one drop at a time, having a volume, for example, of 20 μl, is metered out through outlet opening 24. This may be applied to a substrate, using a dispenser (not shown).

After the content has been metered out, the mixing chamber may be subjected to a cleaning process to remove fluid residues. For this purpose, a cleaning fluid is introduced into mixing chamber 15 through filling openings 16 and then circulated with mixing disk 19, which may be cleaned at the same time. Subsequently, ejection piston 26 expels the cleaning fluid through outlet opening 24.

What is claimed is:

1. A device for mixing at least two substances, comprising:
a mixer housing having a mixing chamber;
a mixing tool arranged in the mixing chamber and configured to be connected to an actuating device; wherein the mixing tool is actuatable similar to a plunger with linear motion.

2. The device according to claim 1, wherein the mixer housing has at least one filling opening.

3. The device according to claim 1, wherein the mixer housing has at least one outlet opening.

4. The device according to claim 3, wherein the at least one outlet opening is configured to cooperate with a metering device.

5. The device according to claim 1, wherein the mixer housing has a vent valve.

6. The device according to claim 1, wherein the mixing tool is configured to rotate.

7. The device according to claim 1, wherein the mixing tool includes a mixing disk attached to a mixing tool shaft that extends to an outside of the mixer housing.

8. The device according to claim 7, wherein a diameter of the mixing disk corresponds to a diameter of the mixing chamber.

9. The device according to claim 8, wherein the mixing disk includes at least one of holes and perforations.

10. The device according to claim 9, wherein axes of the one of holes and perforations are oriented at an angle to the mixing tool shaft.

11. The device according to claim 1, further comprising:
an ejection piston having a piston shaft extending to an outside of the mixer housing.

12. The device according to claim 4, wherein the metering device includes a stem functioning as a valve needle.

13. The device according to claim 12, wherein a mixing tool shaft and a piston shaft are positioned coaxially to each other.

14. The device according to claim 13, wherein the stem is positioned coaxially to the mixing tool shaft and the piston shaft.

15. The device according to claim 1, wherein the at least two substances include at least two fluids.
